(19) United States
(12) Patent Application Publication
(10) Pub. No.: US 2013/0002067 A1
(43) Pub. Date: Jan. 3, 2013

(54) Electric Machine Module Cooling System and Method

(76) Inventor: Michael D. Bradfield, Anderson, IN (US)

(21) Appl. No.: 13/174,554

(22) Filed: Jun. 30, 2011

(51) Int. Cl. H02K 3/24

(52) U.S. Cl. 310/59

(57) ABSTRACT

Embodiments of the invention provide an electric machine module including a housing. The housing can include a machine cavity, a coolant jacket, and at least one coolant aperture positioned through a portion of the housing so that the coolant jacket is fluidly connected to the machine cavity. In some embodiments, an electric machine can be at least partially positioned within the machine cavity and includes a stator assembly. The stator assembly includes a stator core with slots. The stator core can include a weld side and an insertion side. In some embodiments, conductors can be positioned in the slots so that portions of the conductors axially extend from the weld side and the insertion side of the stator core. In some embodiments, at least some of the conductors can be configured and arranged to define a substantially radially-directed aperture between portions of the conductors on the weld side.

### BACKGROUND

Some conventional electric machines include a stator assembly disposed around a rotor assembly. Some stator assemblies include a plurality of conductors positioned within a stator core. During operation of some electric machines, a current flows through the at least some of the conductors. In order to prevent potential short circuit events and or grounding incidents, some conventional configurations for stator assemblies require multiple insulation layers between and amongst the conductors. Although the insulation functions to reduce the risk of short circuits and/or grounding events, the insulation can at least partially inhibit thermal transfer from the electric machine.

### SUMMARY

Some embodiments of the invention provide an electric machine module including a housing. The housing can include a machine cavity, a coolant jacket, and at least one coolant aperture positioned through a portion of the housing so that the coolant jacket is fluidly connected to the machine cavity. In some embodiments, an electric machine can be at least partially positioned within the machine cavity and can include a stator assembly. The stator assembly can include a stator core with slots. The stator core can include a weld side and an insertion side. In some embodiments, conductors can be positioned in the slots so that portions of the conductors axially extend from the weld side and the insertion side of the stator core. In some embodiments, at least some of the conductors can be configured and arranged to define a substantially radially-directed aperture between portions of the conductors on the weld side.

Some embodiments of the invention provide an electric machine module including a housing and an electric machine positioned substantially within the housing. In some embodiments, the electric machine can comprise a stator core including a plurality of slots and a weld end and insertion end axially opposed to one another. In some embodiments, a plurality of conductors can be positioned in the slots and can include a turn portion positioned between at least two leg portions. The two leg portions can include in-slot portions and connection portions. In some embodiments, at least some of the turn portions can extend from the insertion end of the stator core and at least some of the connection portions can axially extend from the in-slot portions on the weld end. In some embodiments, at least a portion of conductors can comprise at least two radially-oriented layers of insulation. In some embodiments, at least a portion of a plurality of radially-oriented apertures can be formed between the radially-oriented layers of insulation on adjacent conductors. In some embodiments, a size of the radially-oriented apertures are at least about 0.7 millimeters in a radial direction.

### DESCRIPTION OF THE DRAWINGS

FIG. 1 is a perspective view of an electric machine module according to one embodiment of the invention.

FIG. 2 is a perspective view of a stator assembly according to one embodiment of the invention.

FIG. 3 is front view of a stator lamination according to one embodiment of the invention.

FIG. 4 is a perspective view of a conductor according to one embodiment of the invention.

FIG. 5A is a partial view a conventional stator assembly.

FIG. 5B is a view of the conventional stator assembly of FIG. 5A.

FIG. 6A is a partial view of a stator assembly according to one embodiment of the invention.

FIG. 6B is a view of the stator assembly of FIG. 6A.

FIGS. 7A and 7B are views of some of the different embodiments of a third insulation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

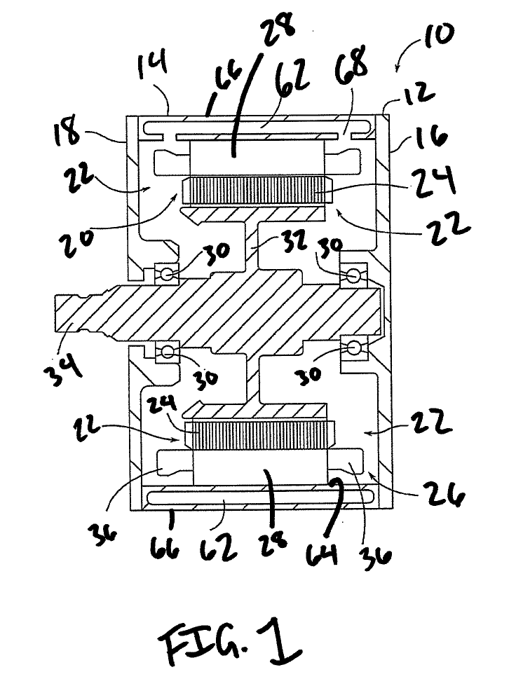

FIG. 1 illustrates an electric machine module 10 according to one embodiment of the invention. The module 10 can include a module housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments the housing 12 can comprise a substantially cylindrical canister and a single end cap (not shown). Further, in some embodiments, the module housing 12, including the sleeve member 14 and the end caps 16, 18, can be fabricated from materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can be, without limitation, an electric motor, such as a hybrid electric motor, an electric generator, or a vehicle alternator. In one embodiment, the electric machine 20 can be a High Voltage Hairpin (HVH) electric motor or an interior permanent magnet electric motor for hybrid vehicle applications.

The electric machine 20 can include a rotor assembly 24, a stator assembly 26, and bearings 30, and can be disposed about an output shaft 34. As shown in FIG. 1, the stator assembly 26 can substantially circumscribe the rotor 24. In some embodiments, the rotor assembly 24 can also include a rotor hub 32 or can have a “hub-less” design (not shown).

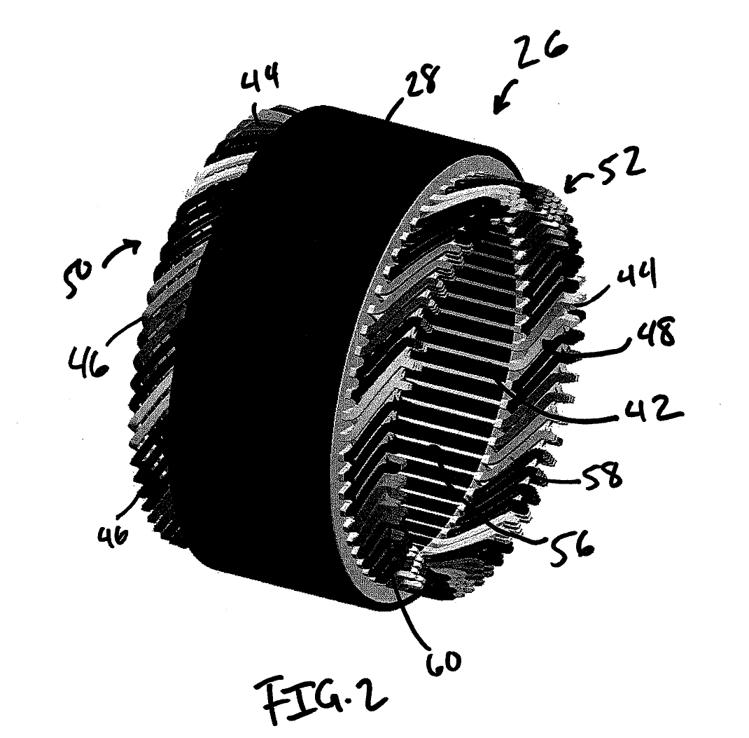

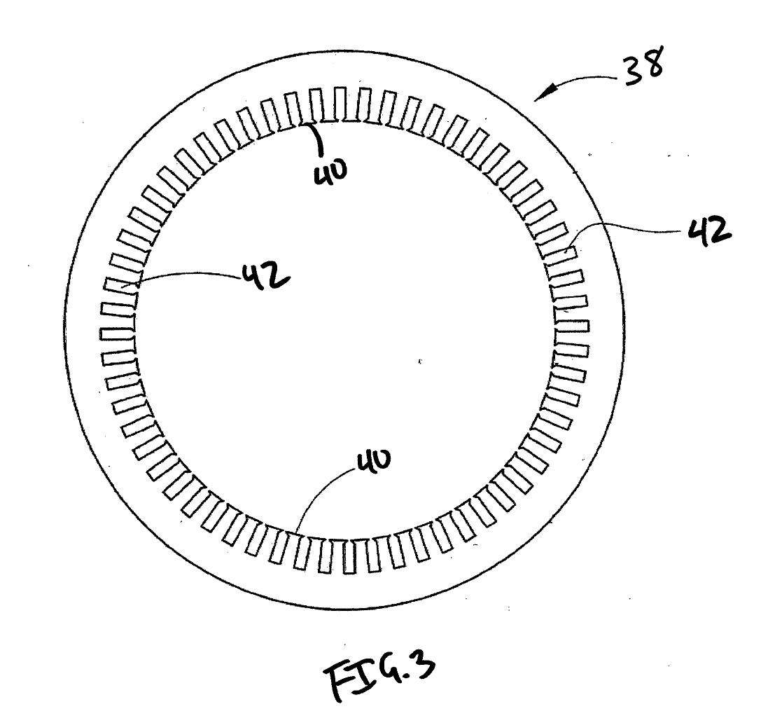

As shown in FIG. 2, in some embodiments, the stator assembly 26 can comprise a stator core 28 and a stator winding 36 at least partially disposed within a portion of the stator core 28. For example, in some embodiments, the stator core 28 can comprise a plurality of laminations 38. Referring to FIG. 3, in some embodiments, the laminations 38 can comprise a plurality of substantially radially-oriented teeth 40. In some embodiments, as shown in FIG. 2, when at least a portion of the plurality of laminations 38 are substantially assembled, the teeth 40 can substantially align to define a plurality of slots 42 that are configured and arranged to support at least a portion of the stator winding 36. As shown in FIG. 3, in some embodiments, the laminations 38 can include sixty teeth 40, and, as a result, the stator core 28 can include sixty slots 42. In other embodiments, the laminations 38 can include more or fewer teeth 40, and, accordingly, the stator core 28 can include more or fewer slots 42.

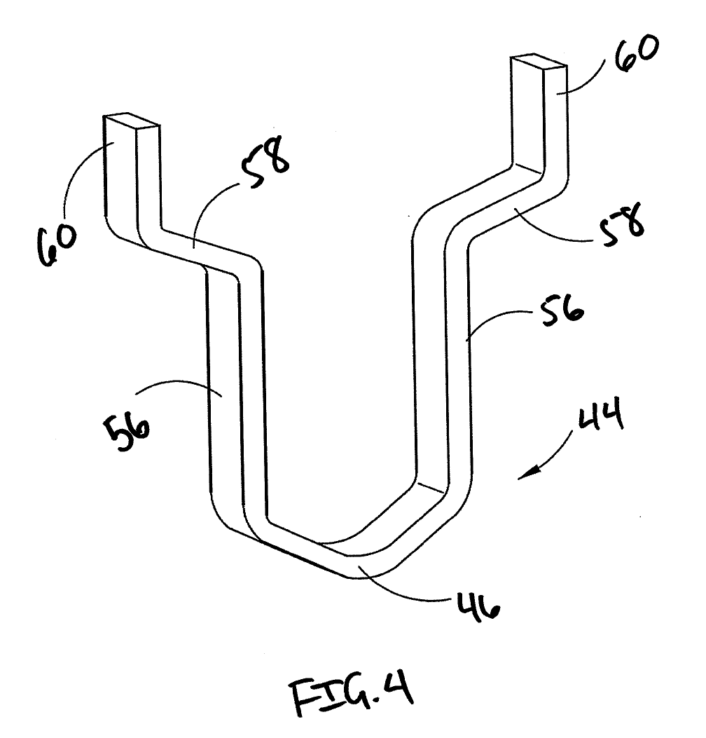

In some embodiments, the stator winding 36 can comprise a plurality of conductors 44. In some embodiments, the conductors 44 can comprise a substantially segmented configuration (e.g., a hairpin configuration), as shown in FIG. 4. For example, in some embodiments, at least a portion of the conductors 44 can include a turn portion 46 and at least two leg portions 48. In some embodiments, the turn portion 46 can be disposed between the two leg portions 48 to substantially connect the two leg portions 48. In some embodiments, the leg portions 48 can be substantially parallel. Moreover, in some embodiments, the turn portion 46 can comprise a substantially “u-shaped” configuration, although, in some embodiments, the turn portion 46 can comprise a v-shape, a wavy shape, a curved shape, and other shapes. Additionally, in some embodiments, as shown in FIG. 4, at least a portion of the conductors 44 can comprise a substantially rectangular cross section. In some embodiments, at least a portion of the conductors 44 can comprise other cross-sectional shapes, such as substantially circular, square, hemispherical, regular or irregular polygonal, etc.

In some embodiments, as shown in FIG. 2, at least a portion of the conductors 44 can be positioned substantially within the slots 42. For example, in some embodiments, the stator core 28 can be configured so that the plurality of slots 42 are substantially axially arranged. In some embodiments, the leg portions 48 can be inserted into the slots 42 so that at least some of the leg portions 48 can axially extend through the stator core 28. In some embodiments, the leg portions 48 can be inserted into neighboring slots 42. For example, in some embodiments, the leg portions 48 of a conductor 44 can be disposed in slots that are distanced approximately one magnetic-pole pitch apart (e.g., six slots, eight slots, etc.). In some embodiments, a plurality of conductors 44 can be disposed in the stator core 28 so that at least some of the turn portions 46 of the conductors 44 axially extend from the stator core 28 at an insertion end 50 of the stator core 28 and at least some of the leg portions 48 axially extend from the stator core 28 at a weld end 52 of the stator core 28.

In some embodiments, the conductors 44 are generally fabricated from a substantially linear conductor 44 that can be configured and arranged to a shape substantially similar to the conductor in FIG. 4. For example, in some embodiments, a machine (not shown) can apply a force (e.g., bend, push, pull, other otherwise actuate) to at least a portion of a conductor 44 to substantially form the turn portion 46 and the two leg portions 48 of a single conductor 44.

In some embodiments, before, during, and/or after shaping of the conductors 44, a first insulation 54 can be applied to at least a portion the conductors 44. For example, in some embodiments, the first insulation 54 can comprise a resinous material such as an epoxy or an enamel that can be reversibly or irreversibly coupled to at least a portion of the conductors 44. In some embodiments, because an electrical current circulates through the conductors 44 during operation of the electric machine 20, the first insulation 54 can function, at least in part, to substantially prevent short circuits and/or grounding events between neighboring conductors 44 and/or conductors 44 and the stator core 28.

In some embodiments, at least some of the leg portions 48 can comprise multiple regions. In some embodiments, the leg portions 48 can comprise in-slot portions 56, angled portions 58, and connection portions 60. In some embodiments, as previously mentioned, the leg portions 48 can be disposed in the slots 42 and can axially extend from the insertion end 50 to the weld end 52. In some embodiments, after insertion, at least a portion of the leg portions 48 positioned within the slots 42 can comprise the in-slot portions 56.

In some embodiments, at least some of a regions of the leg portions 48 extending from stator core 28 at the weld end 52 can comprise the angled portions 58 and the connection portions 60. In some embodiments, after inserting the conductors 44 into the stator core 28, the leg portions 48 extending from the stator core 28 at the weld end 52 can undergo a twisting process (not shown) which can lead to the creation of the angled portions 58 and the connection portions 60. For example, in some embodiments, the twisting process can give rise to the angled portions 58 at a more axially inward position and the connection portions 60 at a more axially outward position, as shown in FIGS. 2 and 4. In some embodiments, after the twisting process, the connection portions 60 of at least a portion of the conductors 44 can be immediately adjacent to connection portions 60 of other conductors 44. As a result, the connection portions 60 can be coupled together to form one or more stator windings 36. In some embodiments, the connection portions 60 can be coupled via welding, brazing, soldering, melting, adhesives, or other coupling methods. Additionally, in some embodiments, at least a portion of the first insulation 54 can be substantially removed at the connection portions 60 in order to enable the coupling process. Although, in some embodiments, the first insulation 54 can be applied to the conductors 44 so that it does not coat and/or cover the connection portions 60.

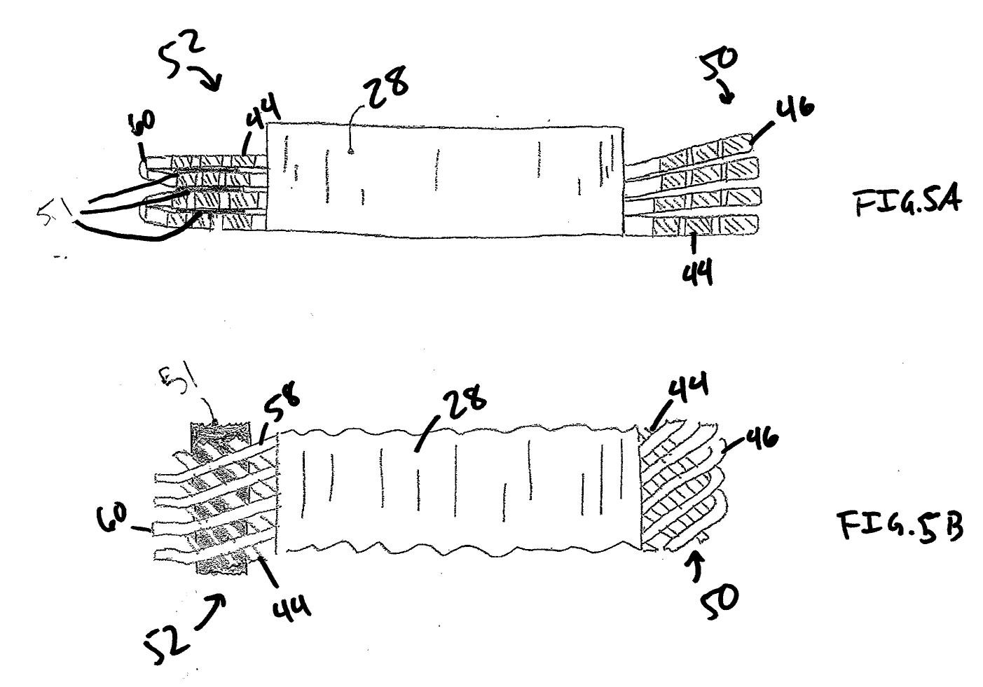

Some conventional electric machines can include an insulation band positioned between adjacent leg portions 48 at the weld end side 52 of the stator core 28, as shown in FIGS. 5A and 5B. For example, in a conventional electric machine including four conductor leg portions per slot, at least three insulation bands 51 can be positioned between the immediately adjacent leg portions (e.g., each leg portion can be layered immediately radially-adjacent to the next leg portion and the insulation band can be positioned between the leg portions), as shown in FIGS. 5A and 5B. The insulation bands 51 can extend in a circumferential direction between the leg portions around at least a portion of the stator core 28.

The insulation bands 51 can serve to protect some portions of the conductors that can be exposed to enable the coupling process. For example, both the conductors 44 and the first insulation 54 can be at least partially damaged by the coupling process (e.g., welding, brazing, thermocoupling, etc.). The insulation band 51 can be used in some conventional electric machines to reduce the damage during the coupling process because the band 51 can shield, protect, and/or guard at least a portion of the weld side 52 conductors 44 and first insulation 54 from the harmful effects of the coupling process.

Further, in some embodiments, after coupling the connection ends 60, at least a portion of the module 10 can be substantially coated in a second insulation (not shown). For example, in some embodiments, a varnish, a resinous material (e.g. an epoxy), another insulating material, or any combination thereof, can be applied to at least some portions of the electric machine 20 to provide an additional layer of insulation to at least partially reduce the chances of a short circuit and/or grounding events between electric machine module 10 components. In some embodiments, the second insulation can be applied by vacuum pressure impregnation, dipping, or other similar application methods. Additionally, in some conventional electric machines, the insulation bands 51 can also be coated in the second insulation, which can cause the bands 51 to become substantially more rigid and can impact thermal dissipation of energy, as discussed below.

Components of the electric machine 20 such as, but not limited to, the rotor assembly 24, the stator assembly 26, and the stator winding 36 can generate heat during operation of the electric machine 20. These components can be cooled to increase the performance and the lifespan of the electric machine 20.

As shown in FIG. 1, in some embodiments, the sleeve member 14 can comprise a coolant jacket 62. For example, in some embodiments, the sleeve member 14 can include an inner wall 64 and an outer wall 66 and the coolant jacket 62 can be positioned substantially between the walls 64, 66. In some embodiments, the coolant jacket 62 can substantially circumscribe at least a portion of the electric machine 20. More specifically, in some embodiments, the coolant jacket 62 can substantially circumscribe at least a portion of an outer diameter of the stator assembly 26, including the stator winding 36 as it extends on both the weld end 52 and the insertion end 50 (e.g., the stator end turns).

Further, in some embodiments, the coolant jacket 62 can contain a coolant that can comprise transmission fluid, ethylene glycol, an ethylene glycol/water mixture, water, oil, motor oil, a mist, a gas, or another substance capable of receiving heat energy produced by the electric machine module 10. The coolant jacket 62 can be in fluid communication with a coolant source (not shown) which can pressurize the coolant prior to or as it is being dispersed into the coolant jacket 62, so that the pressurized coolant can circulate through the coolant jacket 62.

Also, in some embodiments, the inner wall 64 can include coolant apertures 68 so that the coolant jacket 62 can be in fluid communication with the machine cavity 22. In some embodiments, the coolant apertures 68 can be positioned substantially adjacent to the stator end winding 36 as it exits the stator core 28 on at least one of the weld end 52 and the insertion end 50. For example, in some embodiments, as the pressurized coolant circulates through the coolant jacket 62, at least a portion of the coolant can exit the coolant jacket 62 through the coolant apertures 68 and enter the machine cavity 22. Also, in some embodiments, the coolant can contact the stator winding 36, which can lead to at least partial cooling. After exiting the coolant apertures 68, at least a portion of the coolant can flow through portions of the machine cavity 22 and can contact various module 10 elements, which, in some embodiments, can lead to at least partial cooling of the module 10.

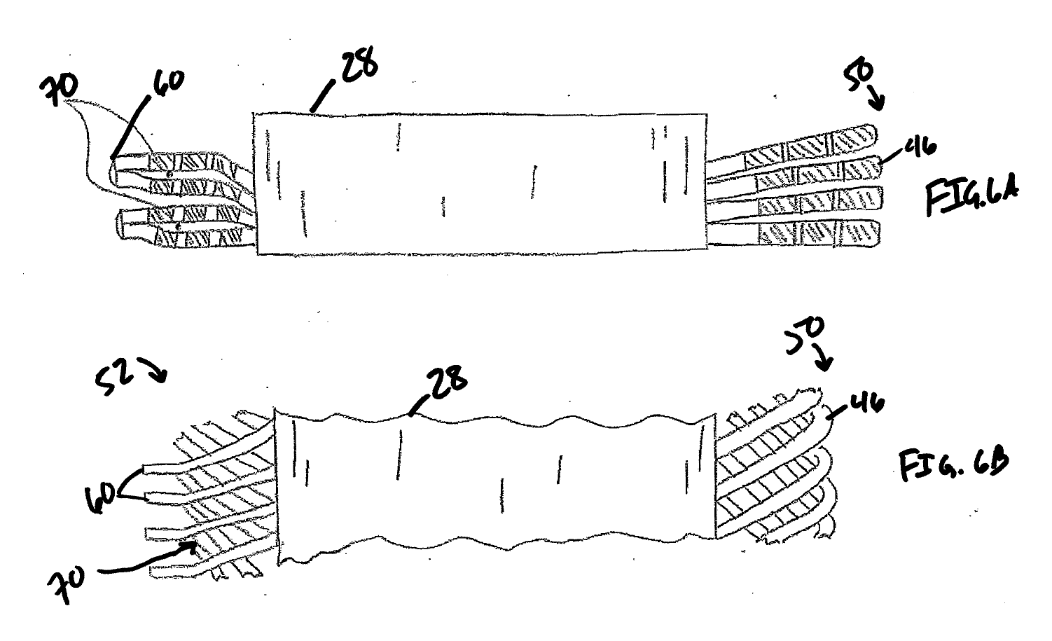

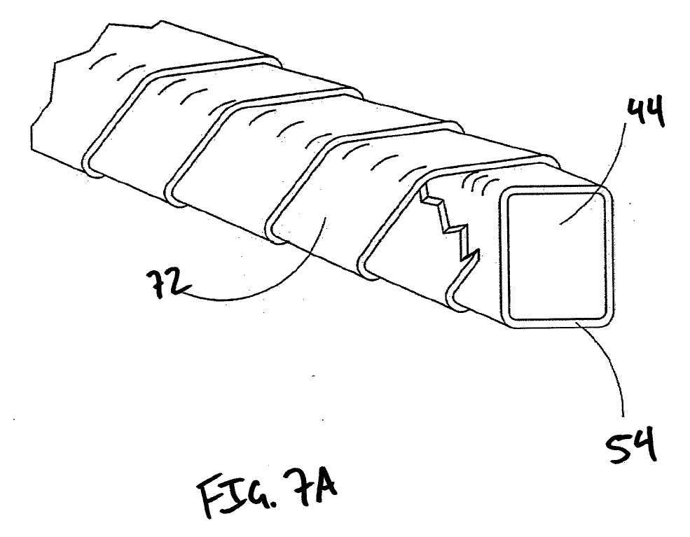

In some embodiments of the invention, the stator winding 36 and/or the conductors 44 can comprise alternative configurations that can at least partially enhance electric machine 20 cooling. In some embodiments, at least some of the leg portions 48 can define at least one radially-oriented aperture 70 between radially-adjacent leg portions 48 at the weld end 52. In some embodiments, on the weld side 52 of the stator assembly 26, the air aperture 70 can be defined between leg portions 48 that extend from same and/or neighboring slots 42. As shown in FIGS. 6A and 6B, in some embodiments, at a point on at least some of the leg portions 48 generally axially adjacent to the stator core 28 (e.g., axially inward from the angled portion 58), the leg portions 48 can be angled, bent, or otherwise receive a force to change the shape of the leg portion 48 so that the aperture 70 is formed. For example, in some embodiments, the leg portions 48 of conductors 44 that include connection portions 60 that will be coupled together can be angled in relatively opposite radial directions relative to each other at the point generally axially adjacent to the stator core 28.

Additionally, in some embodiments, at a point substantially axially distal to the stator core 28 (e.g., at or immediately adjacent to the connection portions 60) the leg portions 48 also can be bent, angled, or otherwise configured and arranged to define another portion of the aperture 70. In some embodiments, the connection portions 60 of at least some of the leg portions 48 that are to be coupled together can comprise regions that are angled toward each other so that the connection portions 60 can be coupled together without substantially changing the size of the aperture 70. For example, in some embodiments, a connection portion 60 of a more radially-outward positioned leg portion 48 can be angled substantially radially-inward while a connection portion 60 of a more radially-inward leg portion 48 that that will be coupled to the more radially-outward positioned connection portion 60 can be angled substantially radially-outward (e.g., angled to face each other to enable the coupling process). In some embodiments, the connection portion 60 of one of the pair to be coupled together can be angled so that the connection portion 60 of the second of the pair to be coupled can be substantially linear. As a result of the angled and/or bent regions of at least some of the leg portions 42 axially extending from the weld side 52, multiple apertures 70 can be defined between some of the conductors 44.

In some embodiments, the apertures 70 can, at least partially, replace the insulation bands 51 used in some conventional electric machines. For example, in some embodiments, the apertures 70 can be dimensioned so that during the coupling process, the aperture 70 between the two conductors 44 to be coupled can be sized large enough so that there is a substantial reduction in damage to the coupled conductors 44 during the coupling process. Moreover, in some embodiments, the aperture 70 can provide an additional layer of insulation between the conductors 44 because electrical current (e.g., current flowing through the stator winding 36 in different phases during electric machine 20 operation) cannot readily travel across the aperture 70.

In some embodiments, the aperture 70 can comprise a dimension of at least about 0.7 millimeters (mm) in a radial direction between two conductors 44 to be coupled together so that coolant can readily flow over and through the conductors 44. For example, in some embodiments, by including the aperture 70 between radially adjacent conductors 44, the damage caused to the conductors 44 and the first insulation 54 can be at least partially reduced without the need for the insulation band 51. In some embodiments, as described in more detail below, apertures 70 of at least 0.7 mm can lead to sufficient dielectric strength of the region between adjacent conductors 44. For example, in some electric machine applications, by including an aperture 70 of at least about 0.7 mm in a radial direction, the air between the adjacent conductors 44 can be of sufficient dielectric strength to sufficiently reduce the risk of a short circuit between the conductors 44. Moreover, thermal concerns can also be addressed by some embodiments including an aperture 70 of 0.7 mm in a radial direction. For example, a boundary layer thickness (e.g., one measurement of convective heat transfer properties) can be at a substantially optimal level when the aperture 70 is at least about 0.7 mm in a radial direction so that heat energy can be substantially efficiently convected from the conductors 44 to enhance cooling.

In some embodiments, the apertures 70 can at least partially improve cooling of the electric machine module 10. For example, in some embodiments, by including at least some apertures 70 between the conductors 44 on the weld side 52, the stator assembly 26 can function without the insulation band required for some electric machines. By functioning without the insulation band, cooling can be improved. For example, the insulation band can at least partially trap at least a portion of the coolant flowing from the coolant apertures 68, which can reduce heat energy transfer efficiency from the stator winding 36 to the coolant. In some embodiments, the apertures 70 can enable at least a portion of the coolant to more easily flow over and around the stator winding 36 on the weld side 52 of the stator assembly 26. As a result of more coolant flowing over and around the stator winding 36 on the weld side 52, more heat energy can be transferred to the coolant, which can at least partially enhance electric machine module 10 operation. In some embodiments, the size of the aperture being greater than or equal to about 0.7 mm can allow for coolant to flow over and around the conductors 44 and substantially reduce the chance for short circuits and/or grounding events, relative to machines that include apertures 70 smaller than 0.7 mm. Additionally, by removing the insulation band 51, the conductors 44 can include more exposed radial, axial, and/or circumferential surface area so that substantially more heat energy can be transferred to the coolant and/or the ambient atmosphere via forced convection. As a result, in some embodiments, cooling can be enhanced and electric machine 20 operations and lifespan can be at least partially improved.

Moreover, the apertures 70 can at least partially reduce a thermal imbalance between the different sides of the stator assembly 26. For example, as previously mentioned, the insulation band can at least partially reduce the ability of coolant to flow over and around the conductors 44 on the weld side 52 of the stator assembly 26, which results in the weld side 52 conductors 44 operating at a higher temperature than the conductors 44 on the insertion side 50 of the stator assembly 26. In some embodiments including the apertures 70, coolant can more readily flow over and around the conductors 44 on the weld side 52, which can be substantially similar to the flow of coolant over the turn portion 46 at the insertion side 50 of the stator assembly 26.

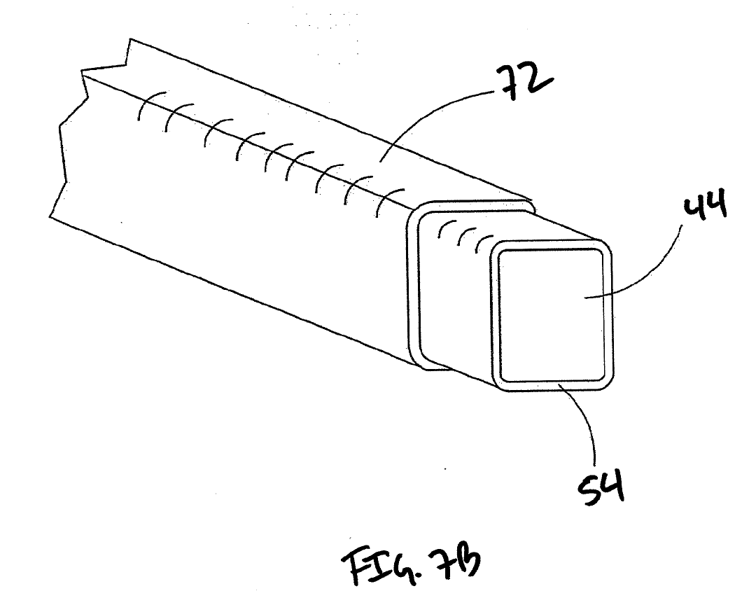

As shown in FIGS. 7A and 7B, in some embodiments of the invention, a third insulation 72 can be applied to at least a portion of the conductors 44. In some embodiments, the third insulation 72 can comprise another coating covering the conductors 44 prior to insertion into the stator core 28. In some embodiments, the third insulation 72 can cover at least a portion of the conductors 44 (e.g., all of the conductor 44 except for an axially outward region of the connection portions 60). In some embodiments, the third insulation 72 can comprise polyimide, polyamide, polyester, polyamideimide, stretched polyethlyene terephthalate film, or other insulation materials. In some embodiments, the third insulation 72 can be coupled to the first insulation 54 and/or the conductors 44 via an adhesive or other similar coupling methods.

In some embodiments, the third insulation 72 can at least partially coat the first insulation 54. For example, in some embodiments, the first insulation 54 and the third insulation 72 can be substantially radially-arranged (e.g., the third insulation 72 can substantially cover the first insulation 54 so that the third insulation is substantially more radially-outward relative to the first insulation 54). In some embodiments, the third insulation 72 can comprise a tube and/or sleeve configuration so that the third insulation 72 can be positioned over the conductors 44. For example, in some embodiments, before bending the conductors 44, the conductors 44 can be slid into and/or the third insulation can be positioned over at least a portion of the first insulation 54 and/or the conductors 44. In some embodiments, the third insulation 72 tube can be heat-sensitive so that after positioning the conductors 44 within the third insulation 72, heat can be applied to the third insulation 72 so that it shrinks to be more tightly coupled to the conductors 44.

In some embodiments, the third insulation 72 can comprise a sheet of the third insulation 72 that can be wrapped around at least a portion of the conductors 44, as shown in FIGS. 7A and 7B. In some embodiments, the sheet of the third insulation 72 can be spirally wrapped around portions of the conductors 44 and/or the first insulation 54. Moreover, in some embodiments, the sheet can be wrapped so that it overlaps itself as more of the conductor 44 and/or first insulation 54 is covered.

In some embodiments, the third insulation 72 can at least partially enhance insulation and cooling in conjunction with the apertures 70. For example, in some embodiments, the third insulation 72 can at least partially enhance any insulation value lost by not including the insulation band. And, because the insulation layers 56, 72 comprise relatively thin thickness (e.g., thousandths of an inch), the third insulation 72 does not substantially reduce the dimensions of the apertures 70.

In some embodiments, the third insulation 72 can be used in multiple electric machine applications. In some embodiments, the third insulation 72 can be used in high voltage applications. For example, in some embodiments, a high voltage electrical current (e.g., greater than 300 volts) can flow through the conductors 44 of the electric machine 20. For some electric machines 14, the high voltage current can increase the chance of short circuits between neighboring conductors, for which the insulation band 51 can be used to minimize the risk. In some embodiments of the invention, the third insulation 72 can be combined with the apertures 70 to provide electrical and mechanical insulation for the conductors 44, which can at least partially reduce the risk of short circuits and/or grounding events.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a housing including a sleeve member coupled to at least one end cap,
an inner wall of the housing at least partially defining a machine cavity,
a coolant jacket defined between the inner wall and an outer wall of the housing, and
at least one coolant aperture positioned through a portion of the inner wall so that the coolant jacket is fluidly connected to the machine cavity; and
an electric machine at least partially positioned within the machine cavity and at least partially enclosed by the housing, the electric machine including
a stator assembly including a stator core with a plurality of slots, the stator assembly including a weld side and an insertion side,
a plurality of conductors positioned in the slots, each of the conductors including a turn portion extending between at least two leg portions, the two leg portions including angled portions and connection portions, wherein at least some of the turn portions of the plurality conductors are positioned on the insertion side and at least some of the angled portions and connection portions are positioned on the weld side, and
at least a portion of the conductors being configured and arranged to define a substantially radially-oriented aperture between at least some leg portions extending from at least one of the plurality of slots at the weld side of the stator core.

2. The electric machine module of claim 1, wherein the aperture comprises a space of at least 0.7 millimeters in the radial direction between adjacent conductors extending from one of the plurality of slots at the weld side of the stator core.

3. The electric machine module of claim 1, wherein at least a portion of the plurality of conductors comprise a first insulation.

4. The electric machine module of claim 3, wherein the first insulation comprises a resinous material.

5. The electric machine module of claim 3, wherein at least a portion of the plurality of conductors comprises a third insulation positioned over an outer perimeter of at least a portion of the first insulation.

6. The electric machine module of 5, wherein the second insulation comprises one of polyimide, polyamide, polyester, polyamideimide, stretched polyethlyene terephthalate film, and a combination thereof.

7. The electric machine module of claim 6, wherein the wherein the aperture comprises a space of at less than one thousandth of a millimeter in the radial direction between adjacent conductors extending from one of the plurality of slots at the weld side of the stator core so that at least a portion of the adjacent conductors are substantially in contact with each other.

8. The electric machine module of claim 1, wherein four leg portions are positioned in at least a portion of the plurality of slots.

9. The electric machine module of claim 7, wherein two of the four leg portions are angled radially-outward at a point adjacent to the stator core and two of the four leg portions are angled radially-inward at a point adjacent to the stator core.

10. The electric machine module of claim 8, wherein at least a portion of the aperture is defined between at least one of the two leg portions angled radially-outward and at least one of the two leg portions angled radially-inward.

11. The electric machine module of claim 7, wherein the leg portions that are angled radially-outward are angled radially-inward at a point substantially adjacent to the connection portion.

12. An electric machine module comprising:
a housing including a machine cavity; and
an electric machine at least partially positioned within the machine cavity, the electric machine including
a stator assembly with a plurality of axially arranged slots, the stator assembly including a weld end and an insertion end,
a plurality of conductors positioned in the slots, each of the conductors including a turn portion extending between at least two leg portions, the two leg portions including in-slot portions and connection portions, wherein at least some of the turn portions of the plurality conductors axially extend from the insertion end and at least some of the connection portions axially extend from the in-slot portions at the weld end,
at least a region of some of the plurality of conductors comprising at least two radially-oriented layers of insulation, and
at least a portion of a plurality of radially-oriented apertures formed between the radially-oriented layers of insulation of adjacent conductors axially extending from the weld end of the stator core, wherein a size of at least some of the plurality of radially-oriented apertures are at least about 0.7 millimeters in a radial direction.

13. The electric machine module of claim 12, wherein the housing comprises a coolant jacket at least partially circumscribing a portion of the stator assembly.

14. The electric machine module of claim 13 and further comprising a plurality of coolant apertures positioned through a portion of the housing so that the coolant jacket is in fluid communication with the machine cavity.

15. The electric machine module of claim 12, wherein four leg portions from four conductors are positioned in at least a portion of the plurality of slots.

16. The electric machine module of claim 15, wherein two of the four leg portions are angled radially-outward at a point adjacent to the stator core and two of the four leg portions are angled radially-inward at a point adjacent to the stator core.

17. The electric machine module of claim 16, wherein at least a portion of the radially-oriented aperture is defined between the radially-outermost layer of insulation of at least one of the two leg portions angled radially-outward and at least one of the two leg portions angled radially-inward.

18. The electric machine module of claim 17, wherein the leg portions that are angled radially-outward are angled radially-inward at a point substantially adjacent to the connection portion.

19. A method of assembling a stator assembly, the method comprising:
providing a plurality of stator laminations including a plurality of teeth;
coupling together at least a portion of the plurality of stator laminations so that the plurality of teeth substantially axially align to form a plurality slots and the laminations form a stator core, wherein the stator core includes an insertion side and a weld side;
inserting a plurality of conductors into the plurality of slots so that a first portion of at least some of the plurality of conductors extends in an axially outward direction from the insertion side of the stator core and a second portion of at least some of the plurality of conductors extends in an axially outward direction from the weld side of the stator core;
configuring at least some of the portion of the plurality of conductors axially extending from the weld side of the stator core to define a radially-oriented aperture between at least a two of the plurality of conductors, wherein a size of the radially-oriented aperture is at least about 0.7 millimeters in a radial direction; and
coupling together an axially outermost portion of at least two of the plurality of conductors positioned substantially adjacent to one another so that the size of at least a portion of the radially-oriented aperture remains substantially the same after the conductors are coupled.

20. The method of claim 19 and further comprising coupling at least two radially-oriented layers of insulation to at least a portion of the plurality of conductors so that the radially-oriented aperture is defined between radially-outermost layer of insulation on the plurality of conductors.
